(19) United States
(12) Patent Application Publication
(10) Pub. No.: US 2026/0250066 A1
(43) Pub. Date: Aug. 27, 2026

(54) Container

(71) Applicant: WHOLLY SHRINK! PTY LTD, Killarney Heights, NSW (AU)

(72) Inventors: Brice Lamarque, Killarney Heights, NSW (AU); Nathan Joseph Ingleby, Killarney Heights, NSW (AU)

(73) Assignee: WHOLLY SHRINK! PTY LTD, Killarney Heights, NSW (AU)

(21) Appl. No.: 18/857,854

(22) PCT Filed: Apr. 20, 2024
(86) PCT No.: PCT/AU2023/050323

§ 371 Date: Oct. 18, 2024

(30) Foreign Application Priority Data
Apr. 20, 2022 (AU) AU2022901039

(51) Int. Cl. B65F 1/06; B65F 1/14

(52) U.S. Cl. CPC B65F 1/06; B65F 1/1405

(57) ABSTRACT

A container (10) includes a receptacle (12) defining a receptacle interior (14) for holding product. The receptacle (12) includes a receptacle opening (16) to provide access to the receptacle interior (14). The container further includes an anchor (18) operatively associated with the receptacle (12). The anchor (18) is adapted to secure a bag within the receptacle interior (14) with an open end of the bag protruding from the receptacle opening (16). The anchor (18) includes an anchor opening (20) adapted to align with the receptacle opening (16) such that product in use passes through the anchor opening (20) and the open end of the bag to be held within the bag inside receptacle interior (14).

### FIELD

The invention concerns a container. In one non-exclusive aspect the invention concerns a container for use in storing soft plastics for recycling purposes.

### BACKGROUND

Plastic bags are versatile and can be supplied in large volumes at low cost. As a result, soft plastics are employed for carrying or enclosing a very large variety of products enroute to domestic settings. As is widely known, soft plastics suffer from a serious drawback in that they are a major cause of environmental pollution. As a result, attempts are ongoing by government and industry to reduce the volume of soft plastics in circulation or to encourage users to recycle their spent bags.

### OBJECT

It is an object of the present invention to provide a container which in one application can be employed for storing soft plastics for recycling purposes.

### SUMMARY

According to a first aspect there is disclosed herein a container including:
a receptacle defining a receptacle interior for holding product, the receptacle including a receptacle opening to provide access to the receptacle interior,
an anchor operatively associated with the receptacle, the anchor adapted to secure a bag within the receptacle interior with an open end of the bag protruding from the receptacle opening, the anchor including an anchor opening adapted to align with the receptacle opening such that product in use passes through the anchor opening and the open end of the bag to be held within the bag insider the receptacle interior.

Preferably the container includes a closure for closing the anchor opening.

Preferably the receptacle is adapted to be configured in (i) a closed condition to hold product within the receptacle interior, and (ii) an open condition to remove product from the receptacle interior.

Preferably the receptacle includes a first receptacle element detachably attachable to a second receptacle element.

Preferably the first receptacle element longitudinally extends between a base and a second receptacle end.

Preferably the first receptacle element includes a first receptacle wall which extends from the base to the second receptacle end.

Preferably the first receptacle wall tapers outwardly from the base to the second receptacle end.

Preferably the second receptacle element longitudinally extends between a first receptacle end and an anchor end.

Preferably the second receptacle element includes a second receptacle wall which extends between the first receptacle end and the anchor end.

Preferably the second receptacle wall tapers inwardly from the first receptacle end to the anchor end.

Preferably the anchor end of the second receptacle element defines the receptacle opening.

Preferably the anchor end of the second receptacle element includes a receptacle lip which extends from the second receptacle wall to define the receptacle opening.

Preferably the first receptacle element includes a first attachment formation at the second receptacle end and the second receptacle element includes a second attachment formation at the first receptacle end, the first attachment formation operatively adapted to engage the second attachment formation.

Preferably the first attachment formation engages the second attachment formation in a snap-lock.

Preferably the anchor longitudinally extends between a receptacle end an anchor opening end.

Preferably the anchor opening end of the anchor defines the anchor opening.

Preferably the anchor includes an anchor wall which tapers outwardly from the anchor opening end to the receptacle end.

Preferably the anchor opening end includes an anchor lip which extends from the anchor wall to define the anchor opening.

Preferably the anchor wall is sized to define a receptacle enclosure adapted to enclose a portion of the second receptacle element.

Preferably the anchor wall is sized to define a receptacle enclosure adapted to enclose the first and second receptacle element.

Preferably the closure includes a plunger body.

### BRIEF DESCRIPTION OF THE DRAWINGS

Preferred embodiments of the invention will be described hereinafter, by way of examples only, with reference to the accompany drawings wherein:

FIG. 1 is an exploded perspective view of a first embodiment container;

FIG. 2 is a front view of the container of FIG. 1;

FIG. 3 is a top view of the container of FIG. 2;

FIG. 4 is a cross-sectional view at the line A-A in FIG. 3;

FIG. 5 is an exploded perspective view of a second embodiment container;

FIG. 6 is a front view of the container of FIG. 5;

FIG. 7 is an exploded perspective view of a third embodiment container;

FIG. 8 is a front view of the container of FIG. 7;

FIG. 9 is a top view of the container of FIG. 8;

FIG. 10 is a cross-sectional view at the line A-A in FIG. 9;

FIG. 11 is an exploded front view of a fourth embodiment container;

FIG. 12 is a top view of the container of FIG. 11;

FIG. 13 is an exploded side view of the container of FIG. 11;

FIG. 14 is front view of a plunger body of the container of FIG. 11;

FIG. 15 is a cross-sectional view of the plunger body at line J-J in FIG. 14;

FIG. 16 is a side view of the plunger body of FIG. 14;

FIG. 17 is an enlarged view of the plunger body at portion h in FIG. 14;

FIG. 18 is a top view of an anchor of the container of FIG. 11;

FIG. 19 is a front view of the anchor of FIG. 18;

FIG. 20 is a cross-sectional view of the anchor at line E-E in FIG. 19;

FIG. 21 is an enlarged view of the anchor at portion F in FIG. 20;

FIG. 22 is a front view of a first receptacle element of the container of FIG. 11;

FIG. 23 is a cross-sectional view of the first receptable element at line C-C in FIG. 22;

FIG. 24 is a front view of a second receptacle element of the container of FIG. 11;

FIG. 25 is a cross-sectional view of the second receptable element at line A-A in FIG. 24;

FIG. 26 is an exploded front view of a fifth embodiment container;

FIG. 27 is a side view of an anchor of the container of FIG. 26;

FIG. 28 is a partial cross-sectional view of the anchor at line G-G in FIG. 27; and

FIG. 29 is a top view of the anchor of FIG. 27.

### DESCRIPTION OF PREFERRED EMBODIMENTS

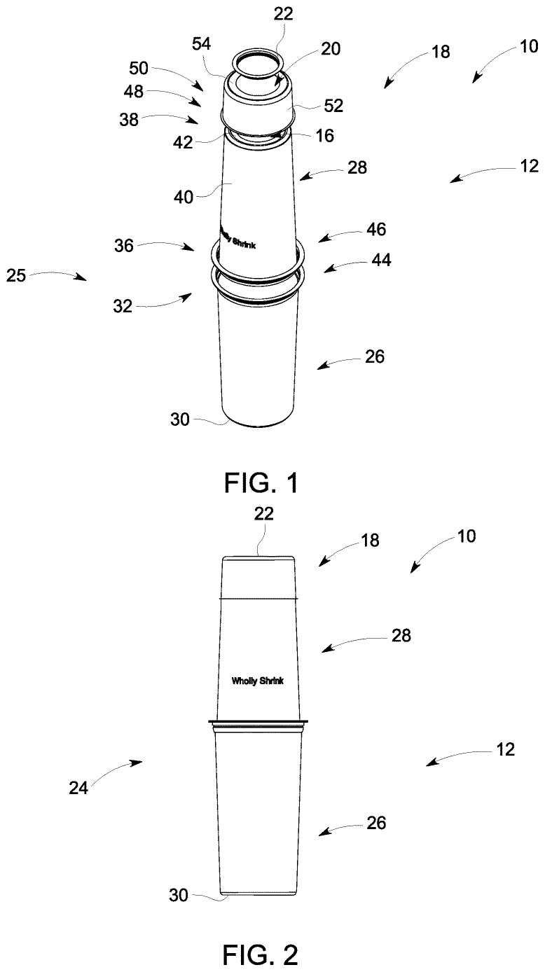

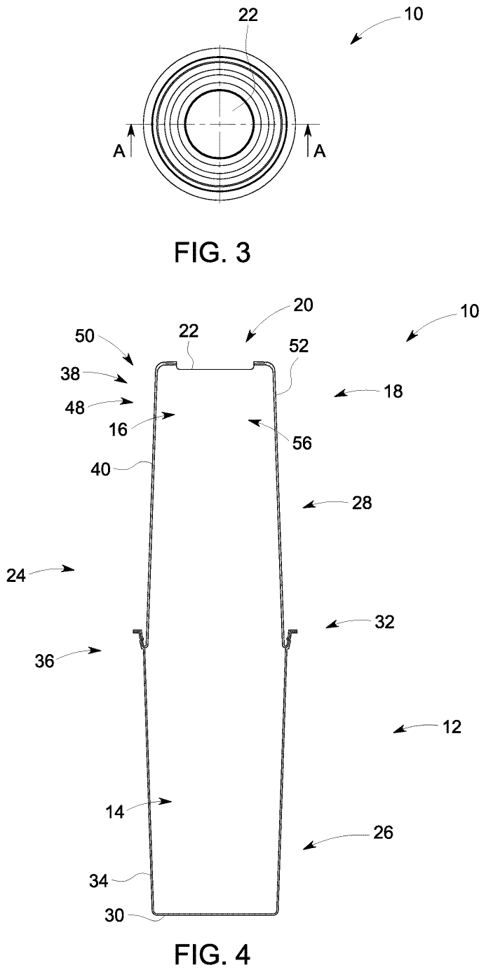

FIGS. 1 to 4 show a first embodiment container, generally indicated with the reference numeral 10. In the below description the container 10 is used for storing soft plastics until a user takes the collected bags to a facility collecting bags for recycling. In one application a user could place the container 10 on a kitchen benchtop and then place soft plastics within the container 10 as the bags are emptied of their contents.

The container 10 includes a receptacle 12. The receptacle 12 defines a receptacle interior 14 for holding product, in this case soft plastics for recycling. The receptacle 12 further includes a receptacle opening 16 to provide access to the receptacle interior 14.

The container 10 includes an anchor 18 operatively associated with the receptacle 12. The anchor 18 is adapted to secure a non-illustrated holding bag within the receptacle interior 14 in such a manner that an open end of the holding bag protrudes from the receptacle opening 16. The anchor 18 includes an anchor opening 20 adapted to align with the receptacle opening 16 such that product, in this case soft plastics such as soft plastic bags, can pass through the anchor opening 20 and the open end of the holding bag to be held within the holding bag inside receptacle interior 14. In operation a user can push a plurality of soft plastics with their fingers through the anchor opening 20 and the open end of the bag into the holding bag held within the receptacle interior 14. Once the holding bag has been filled with soft plastics, the anchor 18 can be removed from the receptacle 12 and the holding bag then removed from the receptacle 12, as described below. The holding bag can now be sealed or closed off until a user transports it to a collecting facility. A new holding bag can be placed inside the receptacle 12 with its open end protruding from the receptacle opening 16 and the open end secured in an open condition by the anchor 18.

The container 10 includes a closure 22 for closing the anchor opening 20 to contain possible odours emanating from bags held within the receptacle 12.

The receptacle 12 is adapted to be configured in (i) a closed condition 24, depicted in FIGS. 2 and 4, to hold product within the receptacle interior 14, and (ii) an open condition 25, depicted in FIG. 1, to remove product from the receptacle interior 14. As shown in FIG. 1 the receptacle 12 includes a first receptacle element 26 detachably attachable to a second receptacle element 28. The receptacle 12 is located in the open condition when the first receptacle element 26 is detached from the second receptacle element 28.

Referring specifically to FIG. 4, the first receptacle element 26 longitudinally extends between a base 30 and a second receptacle end 32. The first receptacle element 26 includes a first receptacle wall 34 which extends from the base 30 to the second receptacle end 32. The embodiment first receptacle wall 34 tapers outwardly from the base 30 to the second receptacle end 32.

The second receptacle element 28 longitudinally extends between a first receptacle end 36 and an anchor end 38. The second receptacle element 28 includes a second receptacle wall 40 which extends between the first receptacle end 36 and the anchor end 38. The second receptacle wall 40 tapers inwardly from the first receptacle end 36 to the anchor end 38. Having tapering first and second receptacle walls 34, 40 enables ease of removal of the holding bag when its filled with bags.

The anchor end 38 of the second receptacle element 28 defines the receptacle opening 16. As shown in FIG. 1, the anchor end 38 of the second receptacle element 28 includes a receptacle lip 42 which extends from the second receptacle wall 40 to define the receptacle opening 16.

The first receptacle element 26 includes a first attachment formation 44 at the second receptacle end 32 and the second receptacle element 28 includes a second attachment formation 46 at the first receptacle end 36. The first attachment formation 44 in this embodiment is operatively adapted to engage the second attachment formation 46 in a snap-lock.

The anchor 18 longitudinally extends between a receptacle end 48 and an anchor opening end 50. The anchor opening end 50 of the anchor 18 defines the anchor opening 20. The anchor 18 includes an anchor wall 52 which tapers outwardly from the anchor opening end 50 to the receptacle end 48. The anchor opening end 50 includes an anchor lip 54 which extends from the anchor wall 52 to define the anchor opening 20. Having a receptacle lip 42 and an anchor lip 54 as described serves to deter bags stored inside the receptacle from escaping through the anchor opening 20.

The embodiment anchor wall 52 is sized to define a receptacle enclosure 56 adapted to enclose a portion of the second receptacle element 32 to be slid across the second receptacle element 28.

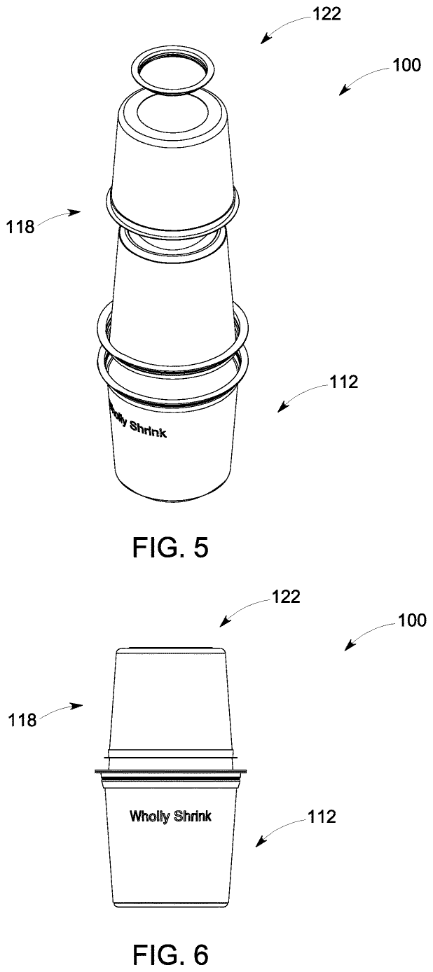

FIGS. 5 and 6 show a second embodiment container 100. Similar to the container 10, the container 100 is used for storing soft plastics for recycling. The container 100 includes a receptacle 112, an anchor 118 and a closure 122 which operate in the same manner as the container 10. The configuration of the container 100, however, is thicker than the container 10 to accommodate larger/thicker bags.

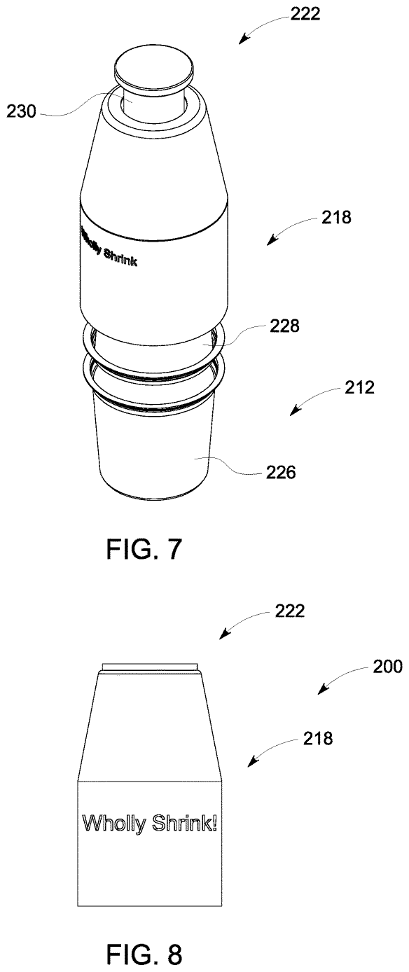

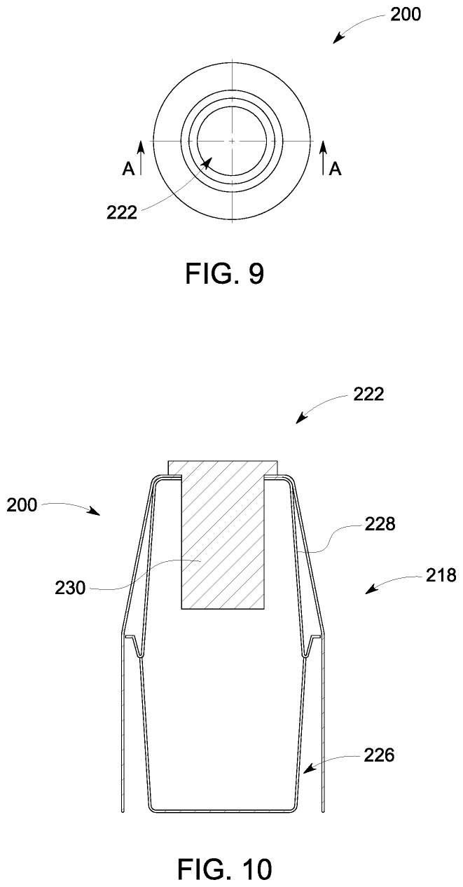

FIGS. 7 to 10 show a third embodiment container 200. Similar to the container 10, the container 200 is used for storing soft plastics until they can be taken to a recycling collection facility. The container 200 includes a receptacle 212, an anchor 218 and a closure 222 which operate in the same manner as the container 10. The container 200, differs for the containers 10 and 100 in that the anchor 218 is configured to enclose the entire receptacle 212, including its first and second receptacle elements 226, 228, to provide a neat appearance.

The closure 222 of the third embodiment container 200 includes plunger body 230 which can extend outwardly of the container 200. Instead of a user employing fingers to push bags into the receptacle 212, the plunger body 230 can be used to push bags down into the receptacle 212.

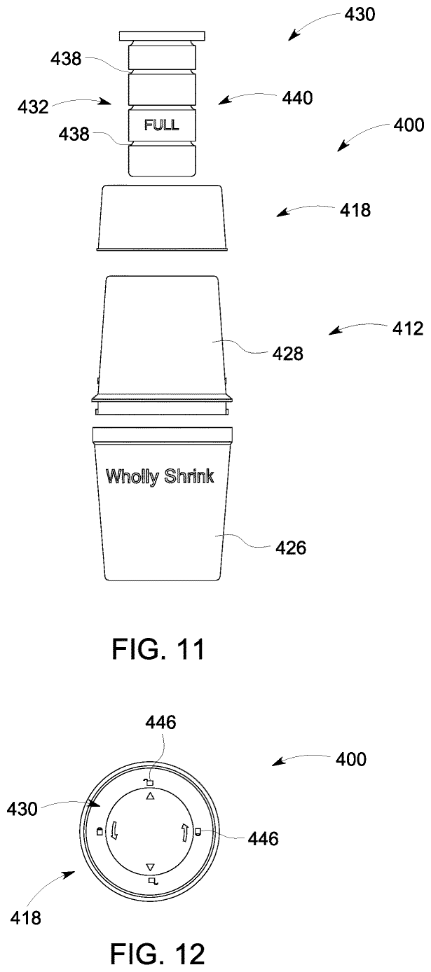

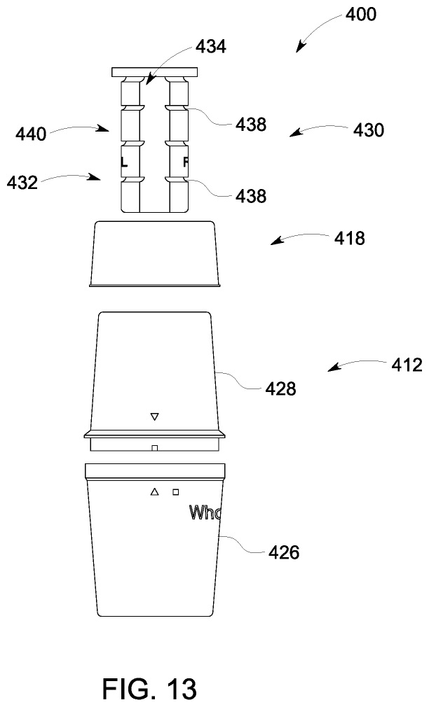

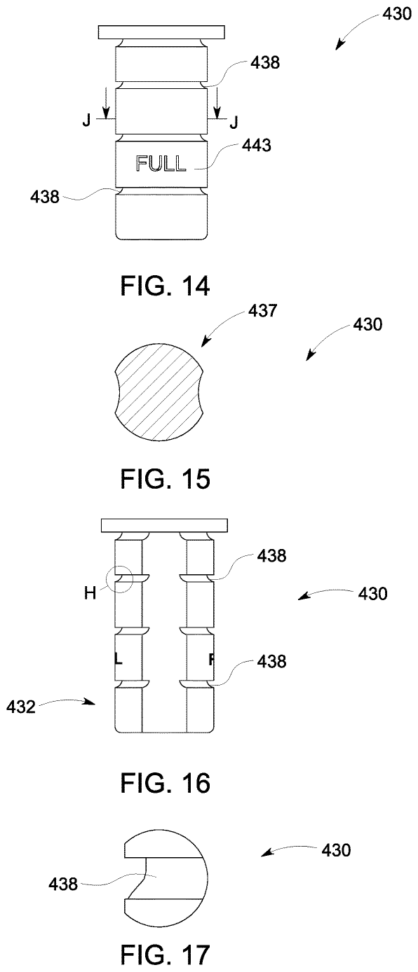

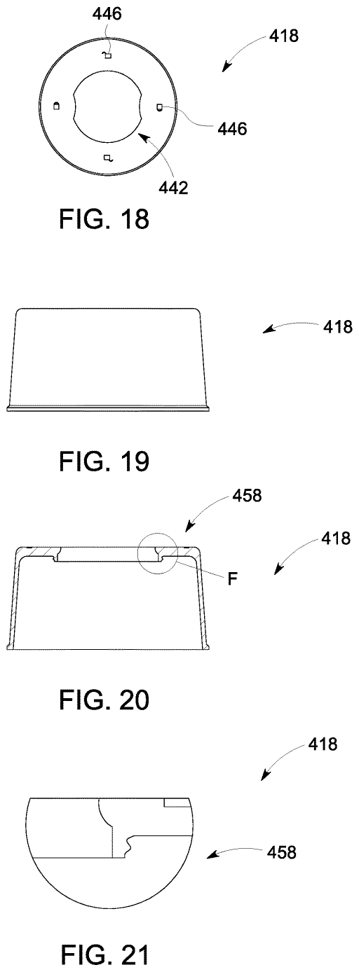

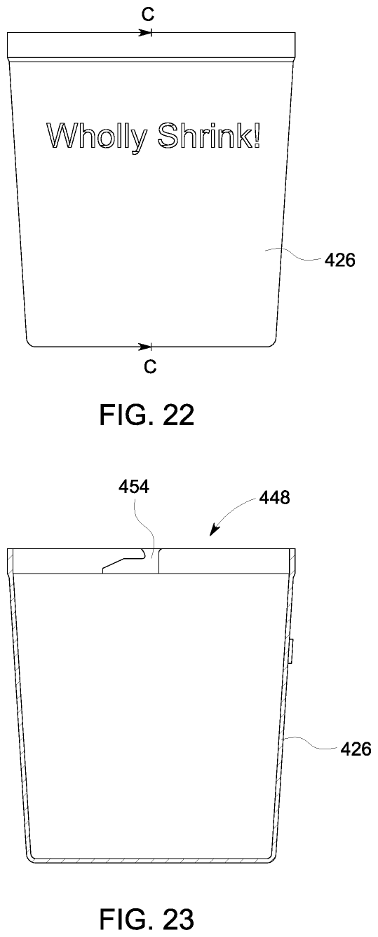

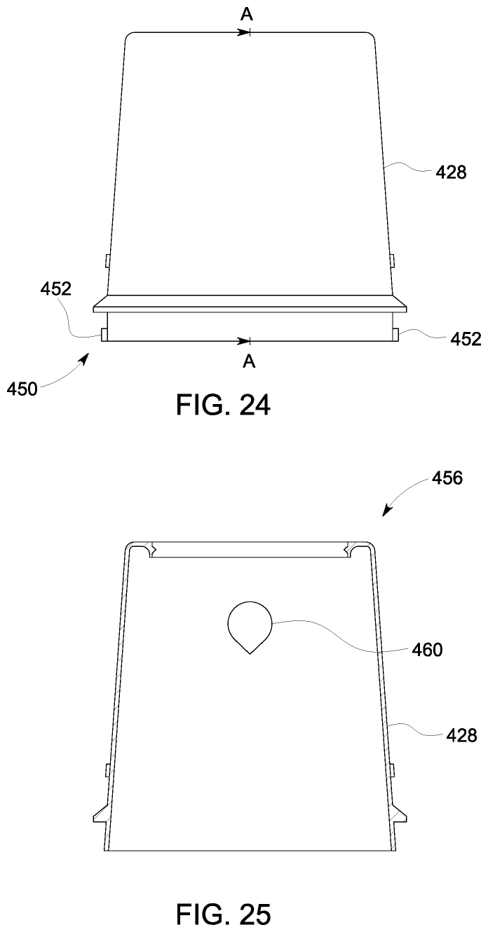

FIGS. 11 to 25 show a fourth embodiment container 400 which, similar to the first embodiment container 10, is used for storing soft plastics until they can be taken to a recycling collection facility. The container 400 includes a receptacle 412, an anchor 418 and a plunger body 430 which is adapted to push and compact soft plastics products within the receptacle 412. To insert soft plastics into the receptacle 412 the plunger body 430 is withdrawn from the receptable 412 and plastics product inserted into the receptable 412 via an anchor opening 420. The plunger body 430 is hereafter replaced to compact the plastics product within the receptacle 412.

The plunger body 430 includes a plunger holding formation 432 and a plunger release formation 434 operatively adapted to cooperate with a complemental anchor holding formation 436 of the of the anchor 418. In this embodiment the plunger holding formation 432 includes a plurality of slots 438 that are longitudinally spaced along a plunger stem 440 of the plunger body 430. The anchor holding formation 436 is defined by a profiled anchor lip 442 at the anchor opening 420. By rotating the plunger body 430, the plunger holding formation 432 can be aligned with the anchor holding formation 436 so that the plunger body 430 is locked in position and cannot be pushed into or extracted from the receptable 412. Further, when it is required that the plunger body 430 be extract from or pushed into the receptacle 412 the plunger body 430 is configured so that it can be rotated to align the plunger release formation 434 with the anchor holding formation 436 in such a manner that the plunger body 430 can pass through the profiled anchor lip 442. To provide a user with a visual indication of the position in which the plunger body 430 is to be located for release or to be held, the anchor 418 includes visual icons 446. The plunger stem 440 also includes marking 443 to provide a visual indication to a user that the receptacle 412 is filled to capacity. The slots 438 define different set positions in which the plunger body 430 can be located as a function of the amount of plastics product held within the receptacle 412.

The receptable 412 includes a first receptable element 426 which is detachably attachable to a second receptable element 428. The first receptacle element 426 includes a first attachment formation 448 and the second receptacle element includes a second attachment formation 450. The first attachment formation 448 is operatively adapted to engage the second attachment formation 450 to secure the first receptable element 426 to the second receptacle element 428. In this embodiment the second attachment formation 450 includes two opposing protrusions 452 which are adapted to be received in and held within profiled slots 454 providing the first attachment formation 448.

The receptacle 412 defines a receptacle coupling formation 456 adapted for engaging a complemental anchor coupling formation 458. In this embodiment the receptable coupling formation 456 and the anchor coupling formation 458 are provided in the form of complemental threaded portions which are adapted to threadingly engage each other.

As illustrated in FIG. 25 the second receptacle element 428 includes a hole 460. The purpose of the hole is to provide an entry point where excess liner bag can be deposited by being pushed by a user's fingers.

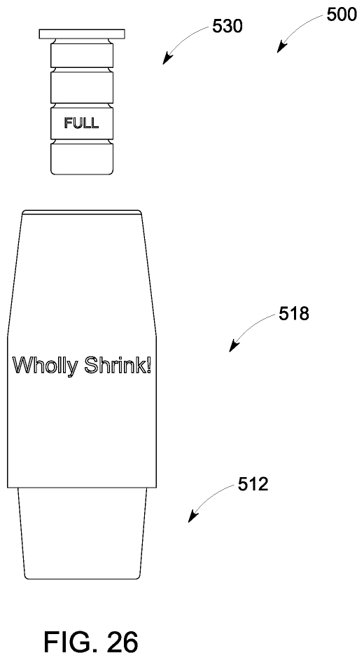

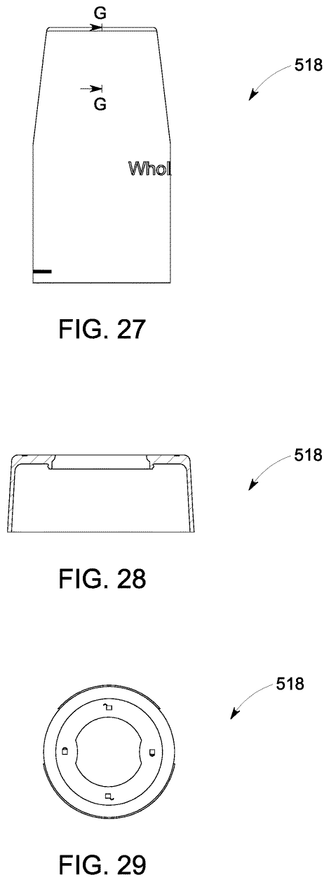

FIGS. 26 to 29 Figures show a fifth embodiment container 500. Similar to the container 400, the container 500 includes a receptacle 512, an anchor 518 and a plunger body 530 which operate in the same manner as the container 400. The container 500, differs for the container 400 in that the anchor 518 is configured to enclose substantially the entire receptacle 512 to provide a neat appearance, similar to the anchor 218 of the container 200 discussed above.

Although the invention has been described with specific reference to plastic bags, it will be appreciated that the invention is not limited to such products or materials.

It will further be appreciated that the bag held by the container could be replaced with another form of liner having an open end which can operate with the receptacle and anchor to receive and hold product.

Although the invention has been described with reference to specific examples, it will be appreciated by those skilled in the art that the invention may be embodied in many other forms.

### KEY TO REFERENCE NUMERALS IN DRAWINGS

10 First embodiment container
12 Receptacle
14 Receptacle interior
16 Receptacle opening
18 Anchor
20 Anchor opening
22 Closure
24 Closed condition
25 Open condition
26 First receptacle element
28 Second receptacle element
30 Base
32 Second receptacle end
34 First receptacle wall
36 First receptacle end
38 Anchor end
40 Second receptacle wall
42 Receptacle lip
44 First attachment formation
46 Second attachment formation
48 Receptacle end
50 Anchor opening end
52 Anchor wall
54 Anchor lip
56 Receptacle enclosure
100 Second embodiment container
112 Receptacle
118 Anchor
122 Closure
200 Third embodiment container
212 Receptacle
218 Anchor
222 Closure
226 First receptacle element
228 Second receptacle element
230 Plunger body
400 Fourth embodiment container
412 Receptacle
418 Anchor
420 Anchor opening
426 First receptacle element
428 Second receptacle element
430 Plunger body
432 Plunger holding formation
434 Plunger release formation 434
436 Anchor holding formation
438 Slots
440 Plunger stem
442 Anchor lip
443 Marking
444 Recess
446 Visual icon
448 First attachment formation
450 Second attachment formation
452 Protrusion
454 Slot
456 Receptacle coupling formation
458 Anchor coupling formation
460 Hole
500 Container
512 Receptacle
518 Anchor
530 Plunger body

1. A container including:
a receptacle defining a receptacle interior for holding product, the receptacle including a receptacle opening to provide access to the receptacle interior; and
an anchor operatively associated with the receptacle, the anchor adapted to secure a bag within the receptacle interior with an open end of the bag protruding from the receptacle opening, the anchor including an anchor opening adapted to align with the receptacle opening such that product in use passes through the anchor opening and the open end of the bag to be held within the bag inside receptacle interior.

2. A container according to claim 1, including a closure for closing the anchor opening.

3. A container according to claim 2, wherein the receptacle is adapted to be configured in (i) a closed condition to hold product within the receptacle interior, and (ii) an open condition to remove product from the receptacle interior.

4. A container according to claim 3 claim 3, including a first receptacle element detachably attachable to a second receptacle element.

5. A container according to claim 4, wherein the first receptacle element longitudinally extends between a base and a second receptacle end.

6. A container according to claim 5, wherein the first receptacle element includes a first receptacle wall which extends from the base to the second receptacle end.

7. A container according to claim 6, wherein the first receptacle wall tapers outwardly from the base to the second receptacle end.

8. A container according to claim 7, wherein the second receptacle element longitudinally extends between a first receptacle end and an anchor end.

9. A container according to claim 8, wherein the second receptacle element includes a second receptacle wall which extends between the first receptacle end and the anchor end.

10. A container according to claim 9, wherein the second receptacle wall tapers inwardly from the first receptacle end to the anchor end.

11. A container according to claim 10, wherein the anchor end of the second receptacle element defines the receptacle opening.

12. A container according to claim 11, wherein the anchor end of the second receptacle element includes a receptacle lip which extends from the second receptacle wall to define the receptacle opening.

13. A container according to claim 12, wherein the first receptacle element includes a first attachment formation at the second receptacle end and the second receptacle element includes a second attachment formation at the first receptacle end, the first attachment formation operatively adapted to engage the second attachment formation.

14. A container according to claim 13, wherein the anchor longitudinally extends between a receptacle end an anchor opening end.

15. A container according to claim 14, wherein the anchor opening end of the anchor defines the anchor opening.

16. A container according to claim 15, wherein the anchor includes an anchor wall which tapers outwardly from the anchor opening end to the receptacle end.

17. A container according to claim 16, wherein the anchor opening end includes an anchor lip which extends from the anchor wall to define the anchor opening.

18. A container according to claim 17, wherein the anchor wall is sized to define a receptacle enclosure adapted to enclose a portion of the second receptacle element.

19. A container according to claim 18, wherein the anchor wall is sized to define a receptacle enclosure adapted to enclose the first and second receptacle element.

20. A container according to claim 15, wherein the closure includes a plunger body.
